(19) United States
(12) Patent Application Publication
(10) Pub. No.: US 2026/0077267 A1
(43) Pub. Date: Mar. 19, 2026

(54) ASSIGNMENT RING SOLVER FOR MULTI-CHARACTER INTERACTION SCENARIO

(71) Applicant: ELECTRONIC ARTS INC., Redwood City, CA (US)

(72) Inventor: HENRY ALLEN, Longwood, FL (US)

(21) Appl. No.: 18/885,098

(22) Filed: Sep. 13, 2024

(51) Int. Cl. A63F 13/537

(52) U.S. Cl. CPC A63F 13/537

(57) ABSTRACT

Systems and methods are provided for identifying slots for rendering characters in the video game during gameplay based on a variety of parameters. The system can, in some examples, determine slot assignments in a way that efficiently minimizes the maximum distance of any character is assigned to a slot while also minimizing the chances of characters crossing paths when entering an interaction from a distance. In some examples, the slot assignments can also satisfy match conditions for a particular slot or prioritize finding characters for mandatory slots.

### BACKGROUND

In some video games, characters in the game have a goal that is partially satisfied from moving from a first location to a second location. Other goals, in addition to movement from a first to a second location, may be considered as well, including collecting items, passing an object between characters, or besting another character in a competition. The characters can progress in the game by any of these methods based on the defined goals of the game.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a block diagram illustrating an exemplary network architecture according to some examples of the disclosure.

FIG. 2 is a block diagram illustrating a character interaction engine according to some examples of the disclosure.

FIG. 3 illustrates a process of assigning characters in an interaction scenario according to some examples of the disclosure.

FIG. 4 is an illustrative placement of characters in slots of an interaction scenario according to some examples of the disclosure.

FIG. 5 is an illustrative placement of characters in slots of an interaction scenario according to some examples of the disclosure.

FIG. 6 is an illustrative displacement of characters in an interaction scenario according to some examples of the disclosure.

FIG. 7 is an illustrative displacement of characters in an interaction scenario according to some examples of the disclosure.

FIG. 8 illustrates a mandatory slot in an interaction scenario according to some examples of the disclosure.

FIG. 9 is an illustrative interaction scenario absent a displacement of a character from a first slot to a second slot according to some examples of the disclosure.

FIG. 10 is an illustrative interaction scenario absent a displacement of a character from a first slot to a second slot according to some examples of the disclosure.

FIG. 11 illustrates a diagrammatic representation of a computing device which may implement the systems and methods described herein.

The figures are not exhaustive and do not limit the present disclosure to the precise form disclosed.

### DETAILED DESCRIPTION

In video games (e.g., a video game application) where the characters move from a first location to a second location, the video game can identify a plurality of slots in the video game to initially place the characters or to place the character in the middle of gameplay (e.g., respawning, relocating, etc.). The characters can be placed in any of the slots at the beginning of the game play. The platform can identify a slot for each character (e.g., based on matching the character with a parameter of the slot) and render the characters for participation in the video game. Once the characters are rendered in the slots, the characters can interact with each other and the game itself using simulations generated by traditional systems, like a physics engine or a cinematics engine. For example, physics engines may simulate animations based on physical movements but may not render as natural an animation as a hand-authored animation sequence may provide. When a cinematics engine is used, a hand-authored animation can simulate projected, smooth movements between the scenes of the gameplay. The cinematics engine may allow for manually cutting sequences to hide a teleport-style placement of the characters.

In general, the placement of the characters may be determined to help facilitate game play and mimic a real-world environment. Each character may be placed in an available slot of an interaction scenario of the video game environment. For example, an interaction scenario may include computer-implemented rules that define movements of the characters and their interactions with other characters, the environment, and other aspects of the gameplay.

The interaction scenario may also define optional or mandatory slots where the characters are placed/rendered to participate in the interaction scenario. The slot can be mandatory when it is required to be filled by a character in order to play the animation associated with an interaction scenario (e.g., a master character, quarterback in football, queen/king, etc.). The slot can be optional when it is not mandatory (e.g., a soldier, part of the defensive line in football, etc.). In some examples, the interaction scenario may be initiated without each of the optional slots being assigned.

In traditional systems, the placement of the characters in the mandatory and optional slots is difficult and can delay gameplay when the characters are misplaced. For example, some traditional systems may predefine placement of the characters into the slots in a particular order, which can limit the flexibility in which characters are allowed to interact (e.g., as defined by rules or the physics/cinematics engines). Alternatively, game developers may choose to always select a particular interaction scenario when one or more characters are present, may choose not to play an animation when only two characters are present, or may select a default set of characters for an interaction (e.g., the two characters with the highest score). When a predetermined set of characters are selected, some traditional systems may leave out characters that are unable to participate in the interaction scenario, or repetitiously select the same characters to participate in the same scenario, causing the non-selected characters to lose interest in the game because of the unfair assignments.

Traditional systems may also assign characters to locations that are much farther from their assigned slot with previous implementations. This can lead to more severe “warping” into an assignment location than what is necessary. This may also result in having other characters wait for an interaction with a master character that is longer than necessary or significantly longer than other character's interactions, because of the additional travel distance of one or more of the characters.

Traditional systems may also cause characters to cross paths on their way to the master character or to other assigned slot positions. The cross-over can lead to collisions and either failed interactions or lower quality game play.

Examples of the present disclosure improve traditional video games by identifying slots for rendering characters in the video game during gameplay based on a variety of parameters. The system can, in some examples, determine slot assignments in a way that efficiently minimizes the maximum distance of any character is assigned to a slot while also minimizing the chances of character crossing paths when entering an interaction from a distance. In some examples, the slot assignments can also satisfy match conditions for a particular slot or prioritize finding character candidates for mandatory slots.

In some examples of the video game described herein, the system may identify a plurality of slots in a video game and a plurality of characters that are rendered for participation in the video game at the plurality of slots. The system may place a first character of the plurality of characters in a first slot of the plurality of slots. Based on a first assignment score of displacing the first character to a second slot of the plurality of slots, the system may displace the first character to the second slot and place a second character of the plurality of characters in the first slot. In other examples, the first character may remain in the first slot and the second character may be placed in the second slot. In either example, optimizing the assignment score may determine which character is placed in the particular slot.

In some examples, the system may add a third character to the plurality of characters placed in the video game. In response to adding the third character, the system may iteratively displace the first character or the second character to a third slot of the plurality of slots and measuring corresponding assignment scores of the displacements. Based on the corresponding assignment scores of the displacements of the first character or the second character, the system may place the third character in the first slot or the second slot that generates a lowest assignment score for displacement of the plurality of characters in the plurality of slots in the video game, and place the plurality of characters in the video game in accordance with assignments and iterative displacement in the plurality of slots.

In some examples, the terms “first/second character” or “first/second slot” are provided, in some examples, without reference to an order or hierarchy. The terms “first” and “second,” for example, may be provided for clarifying the assignment processes described herein. Other terms may be implemented without diverting from the scope of the disclosure, including “current candidate,” “new candidate,” “incumbent candidate,” “next slot,” “adjacent slot,” or “target slot.”

In some examples, objects other than characters may be placed in slots without diverting from the essence of the disclosure. For example, the objects may include locators representing environmental interaction points. In this example, the game may include vaulting over a wall to land on another character's back. Both the interaction point on the wall and the target character can be treated as objects to be placed in slots based on distances/angles to both the wall and the target character.

It should be noted that while the embodiments described herein may refer to specific characters and/or games, the operations described herein are applicable to any character and any game.

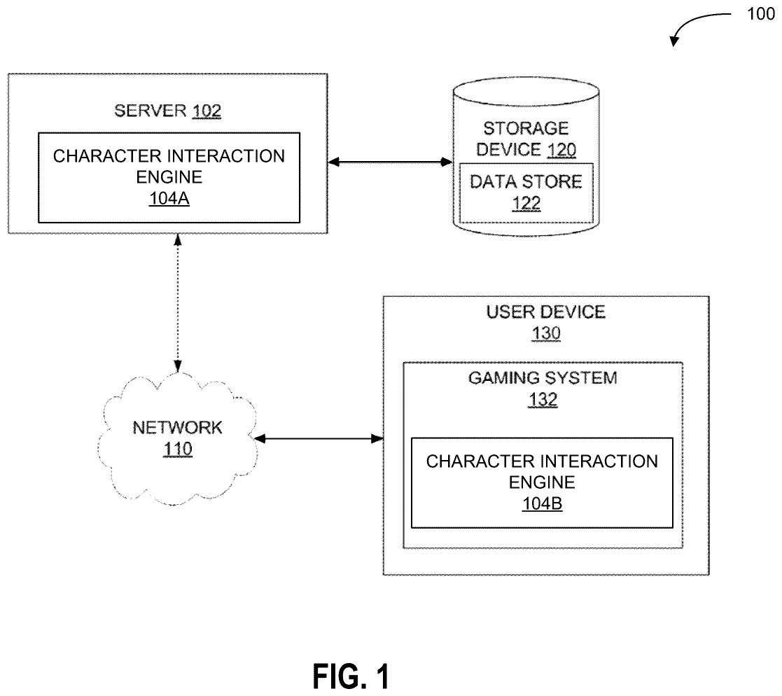

FIG. 1 is a block diagram illustrating an exemplary network architecture according to some examples of the disclosure. In example 100, server 102, network 110, storage device 120, and user device 130 are illustrated. Server 102 may communicate with storage device 120 and user device 130 over network 110, according to one embodiment.

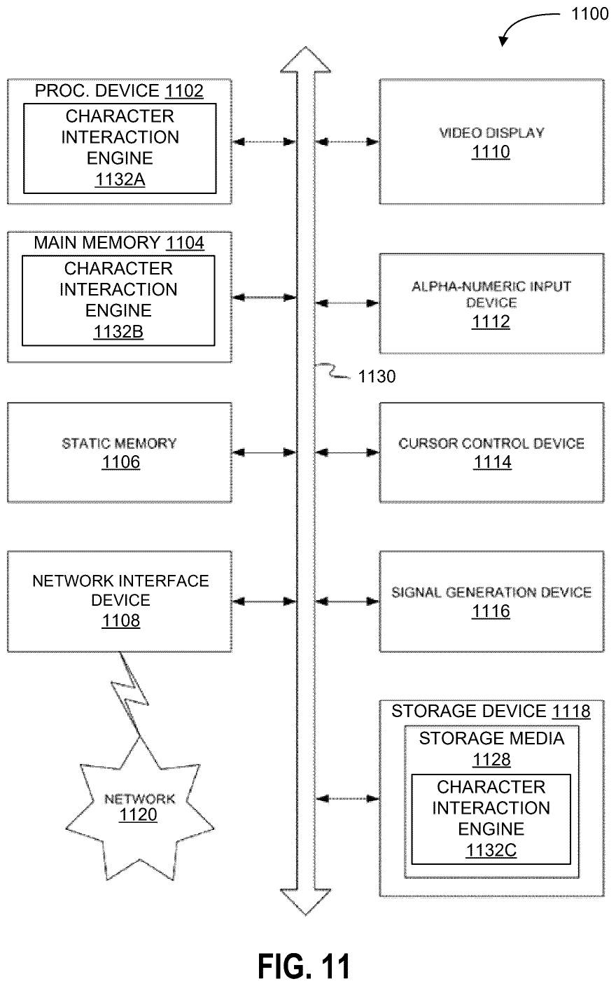

Server 102 may include a network-accessible server-based functionality, various data stores, and/or other data processing equipment. Server 102 may be implemented by a single machine or a cluster of machines, each with processors and memory for executing machine readable instructions that cause server 102 to perform various operations. For example, server 102 may be one server or it may represent multiple servers. In one embodiment, when a first user device connects to server 102 and a second user device connects to server 102, server 102 may be the same server that handles both devices'connections. In another embodiment, when a first user device connects to server 102 and a second user device connects to server 102, server 102 may represent different servers, so that each device connects to a different server. Server 102 may include, for example, the computer system illustrated in FIG. 11.

Server 102 may include character interaction engine 104 (illustrated as character interaction engine 104A). Character interaction engine 104 may determine an initial or subsequent slot for rendering the character in the video game on data provided by storage device 120 or user device 130.

Server 102 may be in communication with storage device 120. In another embodiment, storage device 120 may be external to server 102 and may be connected to server 102 over a network or other connection. In other embodiments, server 102 may include different and/or additional components which are not shown here so as not to obscure the present disclosure. Storage device 120 may include one or more mass storage devices which can include, for example, flash memory, magnetic or optical disks, or tape drives, read-only memory (ROM); random-access memory (RAM); erasable programmable memory (e.g., EPROM and EEPROM); flash memory; or any other type of storage medium.

Storage device 120 may comprise data store 122. Data store 122 may include data provided by server 102 or user devices 130. In another embodiment, data provided by server 102 or user devices 130 are stored elsewhere, outside of data store 122 or storage device 120.

Network 110 can be a local area network (LAN), a wireless network, a telephone network, a mobile communications network, a wide area network (WAN), such as the Internet, or similar communication system.

User devices 130 may be any computing device (e.g., personal computer, server, mobile device, tablet, game system etc.), each with processors and memory for executing machine readable instructions that cause user devices 130 to perform various operations. User device may include, for example, the computer system illustrated in FIG. 11.

User devices 130 may include gaming system 132. In one embodiment, gaming system 132 provides access to a video game including multi-character interaction scenarios, as described herein.

Gaming system 132 may include character interaction engine 104 as an alternative or in addition to the example where character interaction engine 104 is implemented with server 102 (illustrated as character interaction engine 104B). User devices 130 may be connected via network 110.

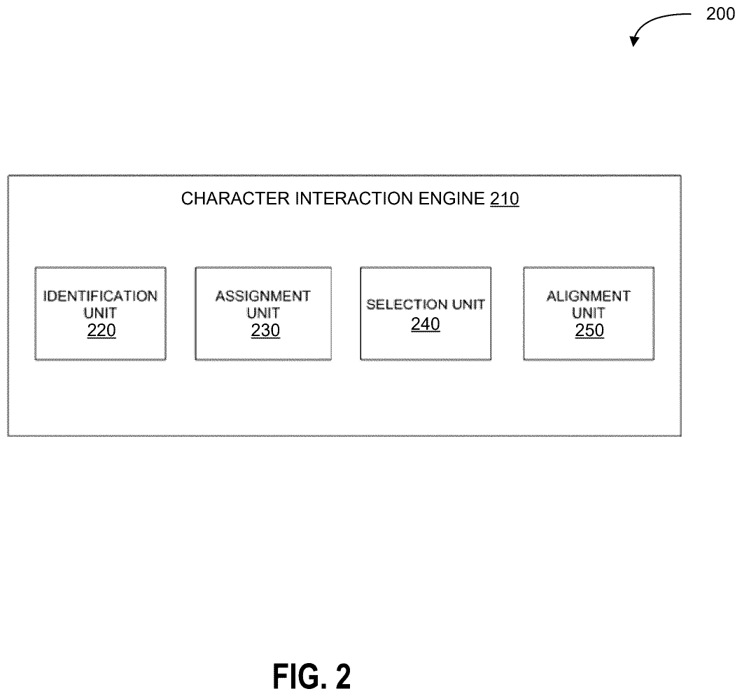

FIG. 2 is a block diagram illustrating a character interaction engine, according to some examples of the disclosure. Character interaction engine may be included in either user device 130 or server 102 of FIG. 1. In example 200, character interaction engine may comprise identification unit 220, assignment unit 230, selection unit 240, and alignment unit 250. This arrangement of units may be a logical separation, and in other embodiments, these units or other components can be combined together or separated in further components, according to a particular embodiment.

Identification unit 220 is configured to identify one or more characters that may be eligible for a particular interaction scenario in the game. Any number of characters may be identified without diverting from the essence of the disclosure. In one embodiment, potentially eligible characters are identified by comparing character characteristics and metrics to predefined identification characteristics and metrics. As an illustrative example, all characters within a certain proximity to a ball carrier in a football game may be identified as potential characters for an animation interaction involving the ball carrier. In another illustrative example, a character is identified by receiving a request from the character to enter an interaction scenario. For example, identification unit 220 may identify all characters who have requested to be added to an interaction scenario.

Assignment unit 230 is configured to assign the identified characters to slots associated with interaction scenario of the game. Identified characters are assigned based on conditions that must be met in order for the character to be assigned to a particular slot in an interaction. For example, a character in a football game may be identified by comparing his “ball carrying?” status to a set of predefined characteristics and metrics. In one embodiment, if the character has a status of “is ball carrying,” the character may be assigned to the “ball carrier” slot in an interaction scenario.

Assignment unit 230 is also configured to take into account physical filters, which may dictate physical relationships between the characters in order for them to be slotted (e.g., Tackler 1 should be in front of the Ball Carrier with a 20 degree tolerance, Tackler 2 at 45 degrees with a 20 degree tolerance, etc.).

The slots may be associated with a slot parameter. For example, the slot parameter may be associated with a master, mandatory, optional, or disabled parameter. A master slot may be the key character in the interaction (e.g., the ball carrier). Optional slots may be for cases where the interaction can occur whether or not a character is available for that slot (e.g., a second tackler). Mandatory slots may mean that the slot must be filled for the interaction to start. Disabled slots may indicate that there is not support for the slot.

In some examples, slots may be skipped during the assignment process. For example, the candidate character may not qualify for an assignment to the slot because the character does not match the logical/game conditions (e.g., not a tackler so the character cannot be assigned to a tackler slot).

In some examples, pre-filters may limit the available slots for assignment as well. As an illustrative example, a tackler character may qualify for TacklerSlot1 and TacklerSlot3 but not TacklerSlot2, based on a distance (e.g., 10 yards) of the character being unsupported by an animation process. There may be no animation available in the animation database that supports a character being assigned at a distance of 10 yards for TacklerSlot2. As such, the logical rules for the game may restrict any character from a slot that is at a pre-defined distance or farther.

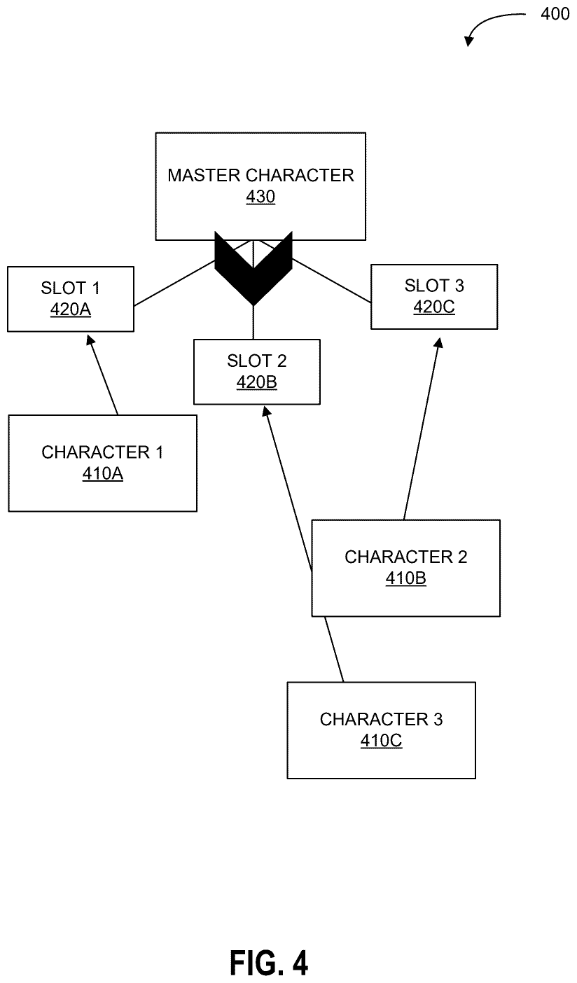

During runtime of the game (e.g., when interactions are being requested) assignment unit 230 may evaluate the identified characters to see which slots they qualify for and, if there are character candidates for all non-optional slots, make the assignments and proceed to selection. In one embodiment, a given slot may have multiple character candidates and/or a character may qualify for multiple slots. Characters may be assigned to slots based on which characters are most likely to yield a successful selection that matches as many of the available character candidates as possible. An illustrative assignment operation is provided in FIG. 4.

In some examples, assignment unit 230 assigns the characters in mandatory slots in a multi-phase process of slot assignments. For example, the characters may be assigned to slots using various methods described herein during a first phase of assignments, while minimizing cross-over interactions between the characters and minimizing the aggregated distance that the characters are predicted to travel to an intended location (e.g., the location of the master character). In a second phase of assignments, assignment unit 230 may shift the characters to be assigned to fill the mandatory slots first. Once each of the mandatory slots are filled, assignment unit 230 may continue to assign the remaining characters to the remaining/optional slots.

Selection unit 240 selects an interaction scenario that includes the one or more identified characters and corresponding assigned animation roles. Selection unit 240 may choose the interaction scenario given a plurality of characters that are to be assigned to slots. Selection unit 240 may read from a table of animations that indicates which animations may be played in a given interaction scenario. In one embodiment, the table may be stored in data store 122 of storage device 120. Each row in the table may represent an animation and each column may represent a context and/or condition that may be required to play a specific animation. The columns may be game logic context (e.g., a game state like “IsDefense”) or physical based (e.g., angle to Ball Carrier). Since the interaction may involve multiple participants and the participants each have their own state, each column supports identifying a slot to associate it with (for example, “Tackler1.IsDefense”). The physical based conditions may be automatically populated by operations that examine the animation associated with that row and apply a user defined tolerance (e.g., Tackler1.AngleTo Ball Carrier may be populated by looking at the sequence for that row and calculating the Angle between Tackler 1 and the Ball Carrier in that particular sequence, then applying a user-defined matching tolerance (e.g., +/−15 degrees).

During game runtime, selection unit 240 may pre-calculate the context values and iteratively select the rows of the table to provide all requirements for all slots that are required and present. If any matches are found, selection unit 240 may select from among the valid choices using various heuristics. For example, selection may be based on animations with more assigned slot participants (e.g., preference may be given to a four-man tackle over a two-man tackle). In one embodiment, the content creator or designer may prefer certain animations to others and assign them a higher priority so they will be preferred. Priority may be given to interaction scenarios that have been chosen less so a user sees more variety. Selection unit 240 may generate an assignment score for the available options based on how well the columns matched, how well the most important columns matched, or some other metric and then choose from among the best scores. If selection unit 240 successfully finds a matching interaction scenario, selection unit 240 may initiate an alignment via alignment unit 250.

Alignment unit 250 is configured to determine an appropriate animation, interaction scenario, and/or state for each character and execute an alignment driver. Alignment unit 250 may determine and pull the characters into alignment as the interaction occurs.

Alignment unit 250 is also configured to align the characters to positions associated with the corresponding assigned animation roles, based on the selected interaction scenario. Alignment may be a rotational alignment, including the complete rotation of characters and the rotation of individual body parts of the characters. Alignment may also include translational movements, where entire characters or body parts of characters are translated from one physical location to another. In one embodiment, alignment unit 250 may align the characters during the animation interaction scenario. Advantageously, aligning during animation, instead of before the animation is allowed to begin, provides for a natural looking animation sequence.

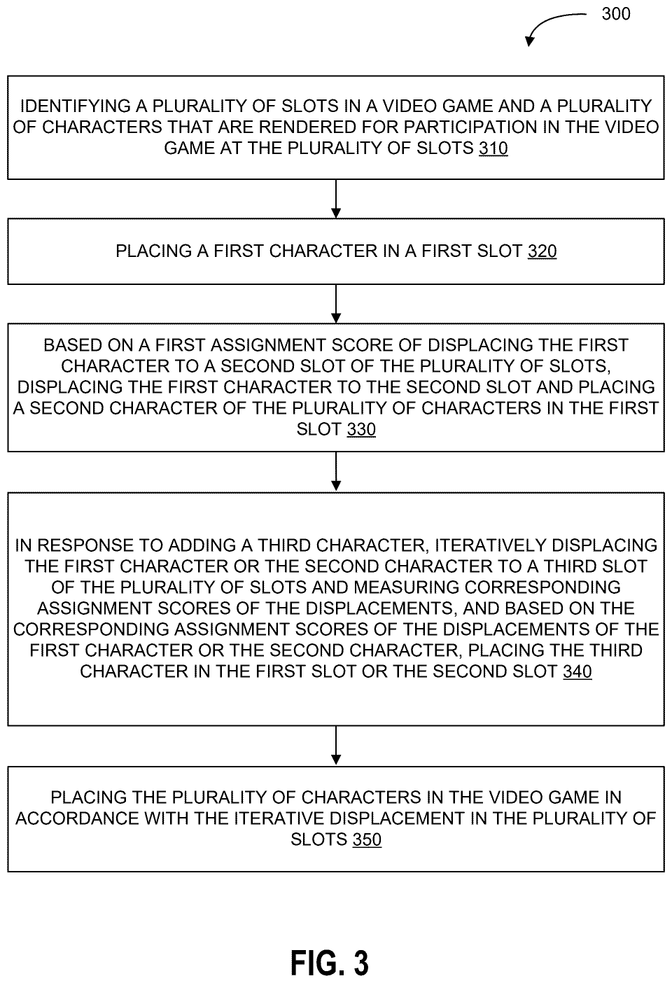

FIG. 3 illustrates a process of assigning characters in an interaction scenario according to some examples of the disclosure. In example 300, a server may execute machine readable instructions by processing logic that comprises hardware (e.g., circuitry, dedicated logic, programmable logic, microcode, etc.), software (e.g., instructions run on a processing device to perform hardware simulation), or a combination thereof.

At block 310, the process may identify a plurality of slots in a video game and a plurality of characters that are rendered for participation in the video game at the plurality of slots. The slots may comprise a set of locations in a scenario of the gameplay. When a character is placed in the slot, the character may occupy the location in the scenario of the gameplay and may be able to move within or outside of the slot.

At block 320, the process may place a first character in a first slot. The placement of the first character in the first slot may follow a set of rules. For example, the set of rules may place the first character in a slot closest to the master character. In another example, the set of rules may place the first character in a slot closest to the current position of the first character. In another example, the slots (and corresponding set of rules) may be defined with respect to the angle that the master character is facing and the distance between the slot and the placement of the master character, such that the first character is placed in a slot closest to the master character and at a particular angle. For example, the system may measure the distance between the character and each of the available slots and select a slot that minimizes the distance between the character and the slot. If one character needs to travel much farther than the rest of the plurality of characters, the other characters may need to wait longer before the interaction can start (e.g., after the initial placement).

The set of rules may assign a relative value for placing a character in a slot. For example, assigning a character to a mandatory slot may have a better relative value than assigning a character to an optional slot. In another example, assigning a character to a slot with a closer distance to a master character may have a better relative value than assigning a character to a slot with a farther distance to the master character. In another example, assigning a character to a slot without crossing over an intended path to a master character may have a better relative value than assigning a character to a slot that is likely to cross over a second character's intended path to the master character. Additional rules may be added or removed based on the interaction scenario or other considerations associated with the video game.

In some examples, the system may iteratively place the characters in available slots in accordance with the set of rules and determine the relative value. When the relative value of the placement is optimized, the placement of the character may be assigned to the slot.

At block 330, based on a first assignment score of displacing the first character to a second slot of the plurality of slots, the process may displace the first character to the second slot, and may place a second character of the plurality of characters in the first slot. In some examples, based on a first assignment score, the displacing may be implemented on the second character and the first character may remain in the first slot.

The “assignment score” or “assignment cost” (used interchangeably) may provide a calculated value that is used in determining whether a particular character remains in the slot or is displaced to a different slot. For example, the assignment score may correspond with creating a minimum aggregated distance between the placed character and the master character, creating a smallest angle between the placed character and the master character, or determining a shortest distance between the placed character and the master character. The distance may be measured between the slot mid-point and the placement location to determine the assignment score. In some examples, optimization of the assignment score may be based on distance and angle from master character (e.g., higher score is better) or based on distance to a slot at the ideal position (e.g., lower cost is better).

In some examples, the assignment score is calculated by the character assignment process in accordance with a parameter. The parameter may correspond with distance, angle, or another value associated with the placement of the character with respect to a master character or mandatory slot. For example, the assignment score may be calculated by measuring the distance from the character to the slot midpoint. In another example, the assignment score may be calculated by measuring an angle that the character must turn to face a master character or mandatory slot. In examples where a slot has a greater assignment score with a first character than an assignment score for the second character to the same slot, the first character may be assigned to the slot.

In some examples, the assignment scores corresponding with a set of character/slot assignments may be compared to other sets of scores and the best set of character/slot assignments may be selected. In this example, the set of assignment scores may be optimized to find the best set of scores for placement of the characters in the available slots. The best assignment score may vary based on the implementation of the game. For example, the best assignment score may be the lowest assignment score or the highest assignment score, without diverting from the essence of the disclosure.

In some examples, a slot may be assigned to a character with the greatest score for that slot. In other words, the best match with the best assignment score may be assigned first. The assignment of the best score may be initiated before assigning the first character to a second slot or assigning the second character to the second slot.

In some examples, the assignment score may be influenced by game logic or context. In this example, the interaction scenario may include a “blocker” slot. The assignment score may be adjusted to help ensure the particular slot is filled with a higher score than scores for other slots, giving priority to the mandatory slot. In some examples, the assignment score may be adjusted to help ensure the mandatory slot is filled without diverting from the scope of the disclosure.

In some examples, the placement of the second character with the first character may avoid crossing lines/paths. The lines/paths may correspond to the projected path that the character must take to travel from the current position to the slot position. In these examples, the system may help avoid characters crashing into each other while moving to a position to interact during gameplay.

In some examples, the slot assignment may place the slots into a doubly linked loop data structure. The slots in the data structure may be ordered based on a parameter (e.g., distance or angle from the master character or other mandatory slot in the interaction scenario). The data structure may be organized in a loop or ring of slots. For example, the first character may be assigned in a slot and the second and subsequent characters may be assigned in second and subsequent slots (e.g., based on the parameter). The next character may be placed in a worst slot based on the slot scores. The slot may be selected for the next character based on the next best parameter (e.g., closest angle) to the master character. The incumbent character may share the same preferred slot who has the closest angle. If the insertion slot is already occupied, the incumbent character is pushed either clockwise or counter-clockwise around the ring into the next slot for which they qualify (if any), recursively pushing other incumbent character as needed. In this example, some slots may be skipped (e.g., when the character does not qualify for the next slot). The system may insert the character into the slot if all blocking incumbent characters can be successfully reassigned. Inserting among characters with the same preferred slot and pushing incumbent characters around the ring may help all characters be assigned into slots while minimizing cross-over.

In some examples, the clockwise displacement of characters and the counter-clockwise displacement of characters may be analyzed for a next potential assignment slot. The displacement process that has the lowest aggregate assignment score may be selected and implemented.

As an illustrative example, suppose that slot two and slot three are already occupied and other additional slots are available to place/displace characters. The displacement process can place the first character into the first slot. As more characters are added, incumbent characters are displaced around a ring of available slots until a slot is identified that is “vacant” (e.g., successful placement) or “occupied” (e.g., failed placement). When the second character is introduced, the characters may be displaced around the ring of available slots in the opposite direction (e.g., first clockwise then counter-clockwise, or vice versa). The system may determine the aggregated assignment scores for both iterations and implement the better aggregate assignment score. In these examples, the characters are being displaced in accordance with a displacement plan around a ring of available slots in the two possible directions and the system determines which plan to implement based on the aggregated assignment score of each plan.

In some examples, the incumbent character remains in the original slot and the next character is placed in the next slot. The determination of which character to displace may be based on the assignment score, such that the new character is displaced to the new slot and the incumbent character remains in the pre-existing slot if the placement results in a better aggregate assignment score.

In some examples, the assignment may satisfy other requirements of assignment rules. These other assignment rules can include filling mandatory slots, minimizing distance to the slot, and allowing cross-over when the characters assigned to the slots can help minimize distance and are less likely to cause a collision when the characters travel from the current position to the slot position.

In some examples, prioritization may be implemented in a different order or have additional factors considered. After the order in which to assign slots has been determined, the actual assignment may be performed by assigning the highest scoring character to a slot (e.g., based on physical conditions matching and/or game logic and/or context). If characters are tied on score, assignment may be determined by determining and assigning the character that is a candidate for fewer slots.

In some examples, the assignment score is calculated prior to displacing any characters. The characters may be displaced based at least in part on the assignment score or the aggregated assignment scores for all characters being placed in particular slots.

At block 340, various actions may be performed in response to adding a next or third character (e.g., after the second character). The actions may comprise, for example, iteratively displacing the first character or the second character to a third slot of the plurality of slots and measuring the corresponding assignment score of the displacements. Based on the corresponding assignment score of the displacements of the first character or the second character, the process may place the third character in the first slot or the second slot.

In some examples, the placement of the third character in the first slot or the second slot may be based on the assignment scores. For example, the third character may be placed in the slot that generates a lowest assignment score for displacement of the plurality of characters in the plurality of slots.

In some examples, the character may be displaced when the aggregated assignment score for the characters assigned to the set of slots can be reduced or otherwise optimized. In this example, the first character may previously be assigned to a first slot associated with a first score. The second character may be assigned to either the first slot or the second slot. If the aggregated score of the slot assignment is greater by displacing the previously assigned first character, the process may initiate the displacement of the first character and assign the second character to the previously occupied slot. In other examples, the characters are maintained in their existing slots and the new character is displaced. In any of these examples, the characters may be displaced to optimize the aggregated assignment score.

At block 350, the process may provide the plurality of characters in the video game in accordance with the iterative displacement in the plurality of slots. For example, the identified characters, the corresponding slots for placing the characters at the start of gameplay, and the selected interaction scenario may be provided to a display of the user device or other interface.

In some examples, the iterative placement/displacement may be executed for a set of characters. The characters may include one to three characters, where each subsequent character is placed in an open slot or displaces a character, and the displaced character is then placed in an open slot or displaces another character. The process may continue for an unknown number of characters (e.g., 32 characters, 100 characters, etc.) and slots (e.g., 32 slots, 100+slots, etc.).

FIG. 4 is an illustrative placement of characters in slots of an interaction scenario according to some examples of the disclosure. The system illustrated in FIG. 1 and throughout the disclosure may execute machine-readable instructions to perform the slot assignment described herein.

In example 400, set of characters 410 (illustrated as first character 410A, second character 410B, and third character 410C) are assigned to set of slots 420 (illustrated as first slot 420A, second slot 420B, and third slot 420C). The placement of the characters 410 may help minimize the aggregated distance (i.e. the parameter associated with the assignment score) for placing each of characters 410 at the particular slots 420.

In some examples, rather than associating the assignment parameter to a distance, the parameter may be associated with an angle with respect to master character 430. In this example, the set of characters 410 may be analyzed and the assignment score for each character may be determined based on the direction that the character faces the master character 430. The assignment score may be minimized so that the placement of the set of characters 410 in association with master character 430 generates the best assignment score for the interactive scenario.

In some examples, multiple parameters may be considered in determining the assignment score. For example, the parameters may comprise an angle, distance, or other parameters defined in the interaction scenario and described throughout the disclosure.

In some examples, the process of assigning a character to a slot may begin with identifying a character and a preferred slot (e.g., assigned to a slot that is the closest to the master character, etc.). If the preferred slot is empty, the character is assigned to the preferred slot. Otherwise, the process may identify each slot with or without an assigned candidate in it. The process may also determine an angle that the assigned character would face with respect to the master character. In some examples, the character may be assigned to the slot with the smallest angle from the master character.

In addition to considering an angle for placement, the process may determine a displacement process for the existing/incumbent characters and the second/next characters. For example, the process may determine whether the incumbent character should be displaced in a clockwise or counter-clockwise slot from the second/next character.

Various plans may be tested when determining the best assignment score for the placement/displacement. For example, the process may determine whether the first character should be displaced by the second character in a clockwise position based on two placement plans. The first plan assigns the first character (incumbent) to the first slot as it was originally assigned and assigns the second character to one slot counter-clockwise to iteratively displace the second character to available slots in that direction. The second plan assigns the second/next character to the first slot and assigns the first character to one slot clockwise to iteratively displace the first character to available slots in that direction.

In other examples, the process may determine whether the first character should be displaced by the second character in a counter-clockwise position based on two placement plans. The first plan assigns the first character (incumbent) to the first slot as it was originally assigned and assigns the second character to one slot clockwise to iteratively displace the second character to available slots in that direction. The second plan assigns the second/next character to the first slot and assigns the first character to one slot counter-clockwise to iteratively displace the first character to available slots in that direction.

In some examples, the process may consider two placement plans based on the slot location to start the placement process. The process may consider where to start the placement process and which two plans are used based on the expected relative direction of the incumbent character as they are sorted by angle from the master character.

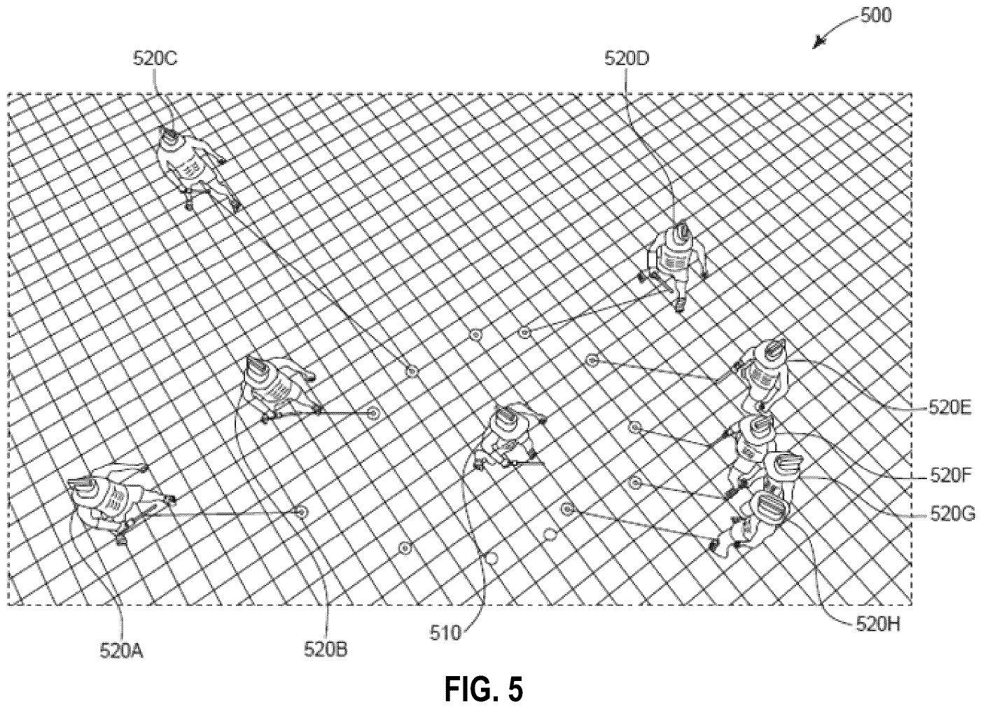

FIG. 5 is an illustrative placement of characters in slots of an interaction scenario according to some examples of the disclosure. The system illustrated in FIG. 1 and throughout the disclosure may execute machine-readable instructions to perform the slot assignment described herein.

In example 500, master character 510 is assigned to a mandatory slot and a set of characters 520 are assigned to other optional slots (illustrated as first character 520A, second character 520B, third character 520C, fourth character 520D, fifth character 520E, sixth character 520F, seventh character 520G, and eighth character 520H). One of the characters satisfying the requirements for placement in the mandatory slot may be assigned to the slot as first character 510. The placement of other characters 520 in the optional slots may be assigned to minimize the aggregated assignment score based on the determined parameter(s) (i.e. the angle, distance, or other parameters defined in the interaction scenario).

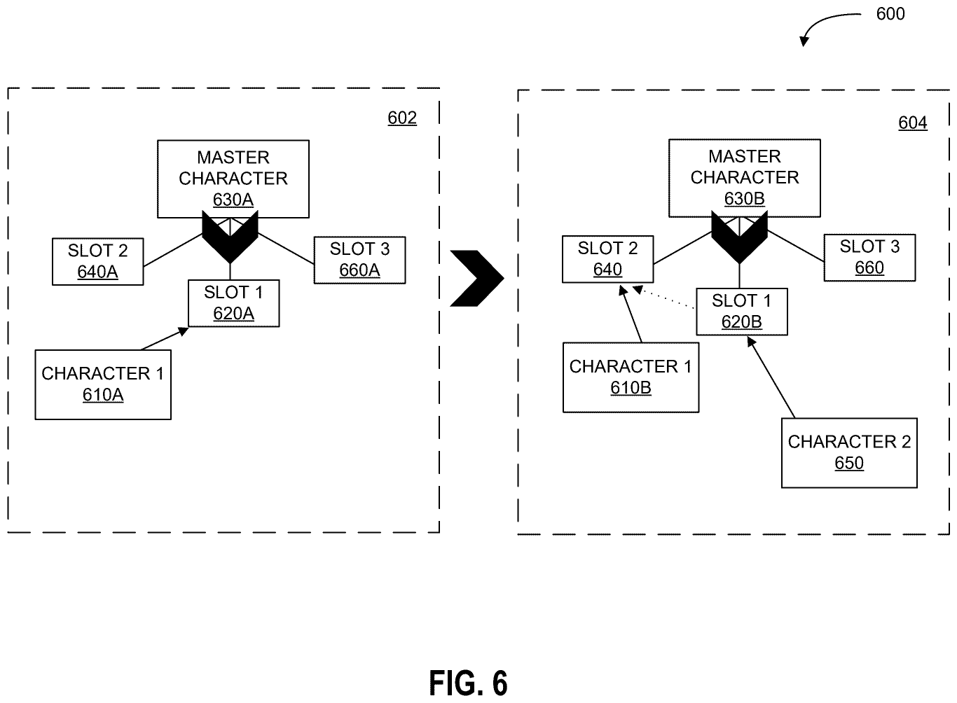

FIG. 6 is an illustrative displacement of characters in an interaction scenario according to some examples of the disclosure. The system illustrated in FIG. 1 and throughout the disclosure may execute machine-readable instructions to perform the slot assignment described herein.

In example 600, first assignment 602 and second assignment 604 are illustrated. In this example, master character 630 is associated with three slots that are available for assignment of the characters, including first slot 620, second slot 640, and third slot 660.

In first assignment 602, first character 610A is introduced to the assignment process. Using the system described throughout the application, first character 610A is assigned to first slot 620A. The assignment of first character 610A to first slot 620A may be based on minimizing the distance between the assignment location and the first character.

In second assignment 604, second character 650 is considered for each of the available slots, including the slot that is previously assigned to first character 610. Using this process, the assignment score is calculated for first character 610B and second character 650 in each of the available slots, including first slot 620B, second slot 640, and third slot 660. The aggregated assignment score of first character 610B and second character 650 may be optimized by displacing the first character from first slot 620B to second slot 640. In this example, the system may displace first character 610B to second slot 640, and may assign second character 650 to first slot 620B that was previously occupied by first character 610B.

In some examples, the aggregated assignment score is compared to multiple iterations of slot assignments. For example, a first assignment score may include aggregated values of assigning the second slot to the first character and assigning the first slot to the second character by displacing the first character. The second assignment score may include aggregated values of assigning the first slot to the first character and assigning the third slot to the second character by displacing the first/third character. The first assignment score may be compared with the second assignment score and the better score may be selected with the corresponding slot assignments.

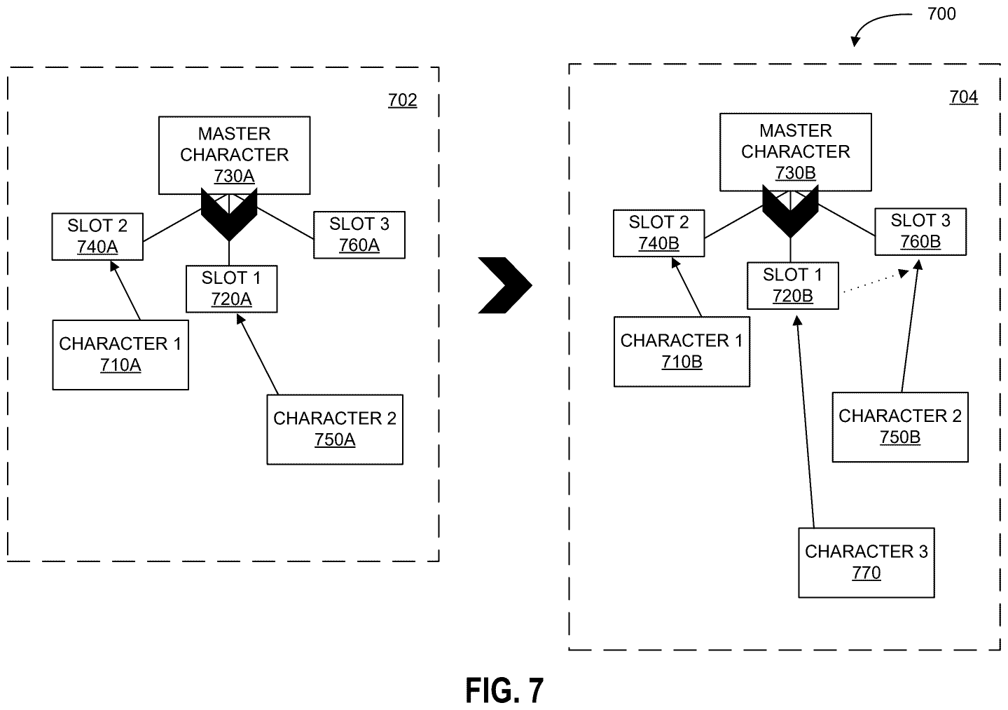

FIG. 7 is an illustrative displacement of characters in an interaction scenario according to some examples of the disclosure. The system illustrated in FIG. 1 and throughout the disclosure may execute machine-readable instructions to perform the slot assignment described herein.

In example 700, second assignment 702 and third assignment 704 are illustrated. In this example, master character 730 is associated with three slots that are available for assignment of the characters, including first slot 720, second slot 740, and third slot 760.

In second assignment 702, first character 710A is previously assigned to second slot 740A and second character 750A is previously assigned to first slot 720A. The assignment of these characters may be based on minimizing the distance or other parameter between the assignment locations and the characters.

In third assignment 704, third character 770 is considered for each of the available slots, including the slot that is previously assigned to first character 710B and second character 750B. Using this process, the assignment score is calculated for first character 710B, second character 750B, and third character 770 in each of the available slots, including first slot 720B, second slot 740B, and third slot 760B. The aggregated assignment score may be optimized by displacing second character 750B from first slot 720B to third slot 760B. In this example, the system may displace second character 750B to third slot 760B, and may maintain the assignment of first character 710B to second slot 740B and assign third character 770 to first slot 720B that was previously occupied by second character 750B.

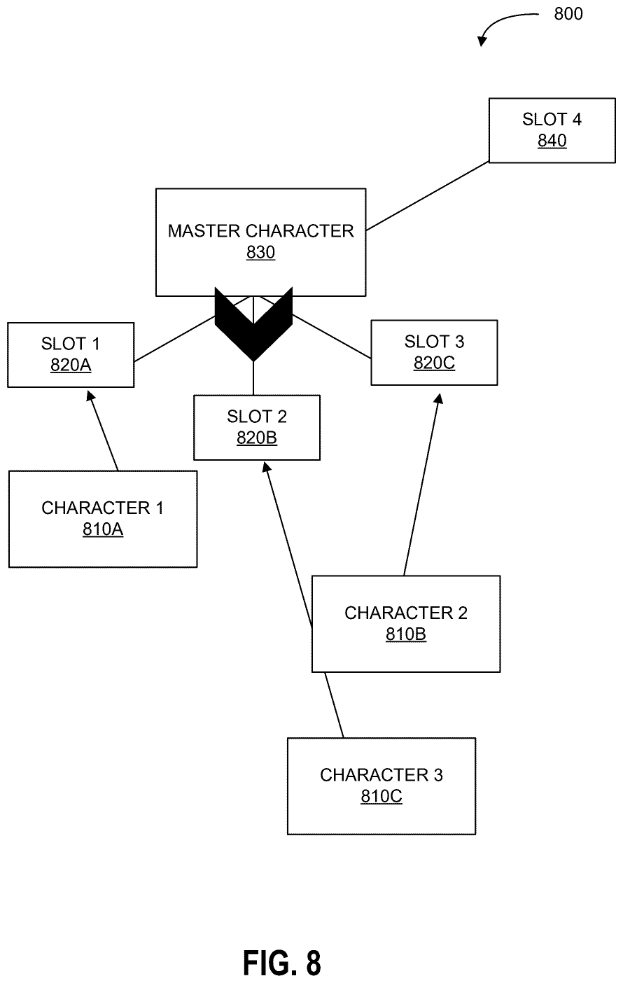

FIG. 8 illustrates a mandatory slot in an interaction scenario according to some examples of the disclosure. The system illustrated in FIG. 1 and throughout the disclosure may execute machine-readable instructions to perform the slot assignment described herein.

In example 800, a plurality of slots 820, 840 are illustrated around master character 830, including mandatory slot 840 and optional slots 820 (e.g., first slot 820A, second slot 820B, and third slot 820C). In this example, characters 810 may be assigned to the optional slots 820 and no characters may be assigned to mandatory slot 840.

In some examples, mandatory slot 840 may be required to be filled by a character in order to play the animation associated with an interaction scenario (e.g., a master character, quarterback in football, queen/king, etc.). In this example, the interaction scenario may not be initiated until the mandatory slot 840 is filled, even though each of the optional slots 820 are assigned to characters 810.

In some examples, before abandoning the interaction scenario based on not filing mandatory slot 840, the system may initiate a second phase of assignments. The second phase may leverage the same data structure to fill any vacant mandatory slots by displacing the candidates into mandatory slot 840 from an adjacent slots.

As an illustrative example of the second phase of assignments, mandatory slot 840 is initially unassigned to a character so the system may check adjacent slots for candidates who qualify for mandatory slot 840 (e.g., check first slot 820A and third slot 820C). If second character 810B, which is originally assigned to third slot 820C but qualifies to be assigned to mandatory slot 840, the system may displace second character 810B into mandatory slot 840 and vacate third slot 820C.

In some examples, the second phase of assignments is a recursive or iterative process. As an illustrative example, if third slot 820C is also mandatory, the system can assign another character to the second mandatory location at third slot 820C.

In some examples, both assignment directions may be considered, including clockwise and counter-clockwise assignments. The assignment direction may be selected based on the optimized aggregate assignment score.

In some examples, the second phase of assignments may allow cross-over or skip a candidate character from being assigned in a particular slot. The system may allow cross-over when the assignment of the slot results in a significant difference to the aggregated assignment score (e.g., significant reduction cost).

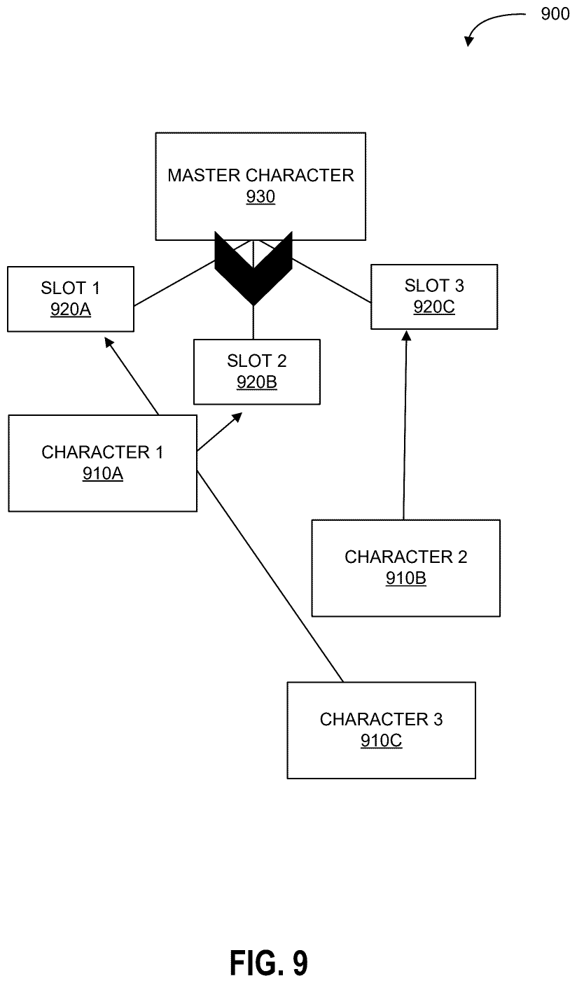

FIG. 9 is an illustrative interaction scenario absent a displacement of a character from a first slot to a second slot according to some examples of the disclosure. The system illustrated in FIG. 1 and throughout the disclosure may execute machine-readable instructions to perform the slot assignment described herein.

In example 900, an assignment rule may be suspended or removed that limits crossover between the characters and the predicted path of the character, as shown between first character 910A being assigned to second slot 920B and third character 910C being assigned to first slot 920A. When the assignment rule is active, first character 910A may be displaced to first slot 920A to limit the overlapping between the predicted paths of first character 910A and third character 910C.

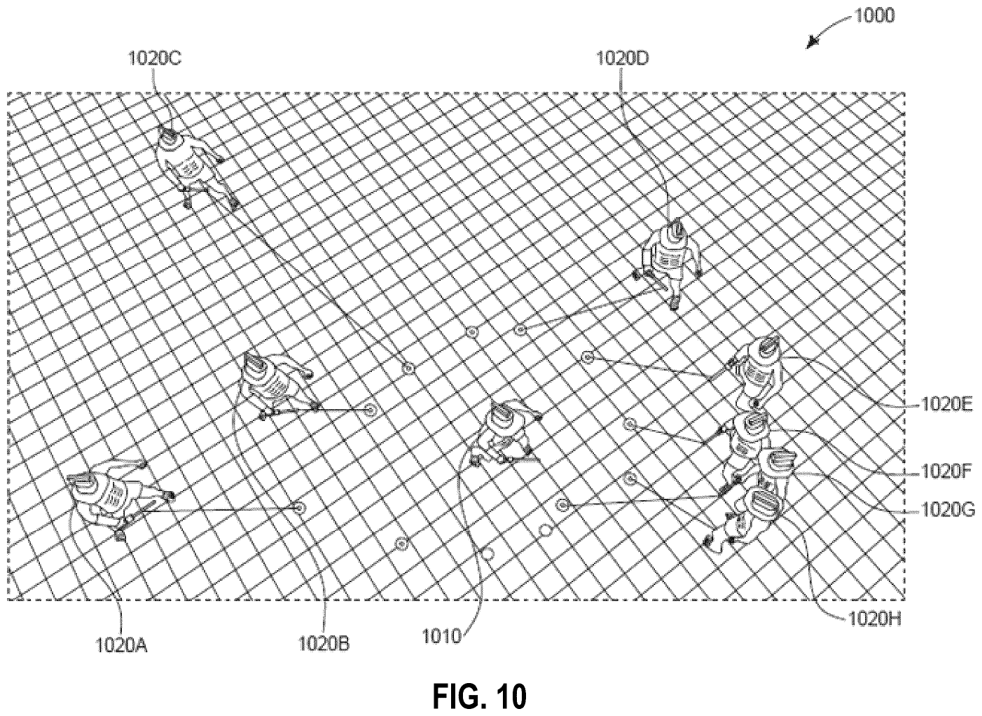

FIG. 10 is an illustrative interaction scenario absent a displacement of a character from a first slot to a second slot according to some examples of the disclosure. The system illustrated in FIG. 1 and throughout the disclosure may execute machine-readable instructions to perform the slot assignment described herein.

In example 1000, master character 1010 is assigned to a mandatory slot and the set of characters 1020 are assigned to other optional slots (illustrated as first character 1020A, second character 1020B, third character 1020C, fourth character 1020D, fifth character 1020E, sixth character 1020F, seventh character 1020G, and eighth character 1020H).

In this example, an assignment rule may be suspended or removed that limits crossover between the characters and the predicted path of the character, as shown between seventh character 1020G and eighth character 1020H being assigned to paths that are predicted to overlap or crossover. When the assignment rule is active, first seventh character 1020G from the original assignment slot to another slot to limit the overlapping between the predicted paths of seventh character 1020G and eighth character 1020H.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

FIG. 11 illustrates a diagrammatic representation of a computing device 1100 which may implement the systems and methods described herein. Computing device 1100 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a laptop computer, a video game console, a (mobile) smartphone device, a (mobile) tablet device, a head mounted display device, or any machine including hardware capable of executing a set of instructions (sequential or otherwise) that specify actions or operations to be taken by that machine. Further, while only a single computing device is illustrated, the term “computing device” shall also be taken to include any collection of computing devices that individually or jointly execute a set (or multiple sets) of instructions to perform the methods discussed herein.

Computing device 1100 may include one or more of processing device 1102 (e.g., graphics processing unit (GPU), central processing unit (CPU), or a general purpose processor), main memory 1104 (e.g., synchronous dynamic random access memory (DRAM), read-only memory (ROM)), static memory 1106 (e.g., flash memory and data storage device 1118), which may communicate with each other via bus 1130. In some examples, computing device 1100 may comprise an integrated GPU (e.g., a CPU-based GPU) and/or a dedicated GPU for graphics rendering.

Processing device 1102 may be provided by one or more general-purpose processing devices such as a microprocessor, central processing unit, or the like. In an illustrative example, processing device 1102 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1102 may also comprise one or more special-purpose processing devices such as an application specific integrated circuit (ASIC), a field programmable gate array (FPGA), a digital signal processor (DSP), network processor, or the like. Processing device 1102 may be configured to execute character interaction engine 104 for carrying out multi-character interaction scenario operations, in accordance with one or more aspects of the present disclosure, for performing the operations and steps discussed herein.

Computing device 1100 may further include network interface device 1108 which may communicate with network 1120. Computing device 1100 also may include video display unit 1110 (e.g., a liquid crystal display (LCD)), alphanumeric input device 1112 (e.g., a keyboard), cursor control device 1114 (e.g., a mouse), and acoustic signal generation device 1116 (e.g., a speaker). In one embodiment, video display unit 1110, alphanumeric input device 1112, and cursor control device 1114 may be combined into a single component or device (e.g., an LCD touch screen).

Data storage device 1118 may include a computer-readable storage medium 1128 on which may be stored one or more sets of instructions, e.g., instructions of character interaction engine 104 for carrying out multi-character interaction scenario operations, in accordance with one or more aspects of the present disclosure. Instructions implementing module 1126 may also reside, completely or at least partially, within main memory 1104 and/or within processing device 1102 during execution thereof by computing device 1100, main memory 1104 and processing device 1102 also constituting computer-readable media. The instructions may further be transmitted or received over network 1120 via network interface device 1108.

While computer-readable storage medium 1128 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

By way of example and not limitation, a video game as used herein refers to a video game application comprising computer executable instructions that, when executed by a computing device (e.g., associated with a processor and memory), provide a virtual interactive environment for gameplay, such as by users or players of the video game. In some embodiments, one or more video game applications are accessible through a video game platform. As a non-limiting illustrative example, a video game platform is a software that enables users or players to manage or access video game applications and/or video game content, among other things.

As known to a person of ordinary skill in the art, a game engine uses data (e.g., state data, render data, simulation data, audio data, and other data types of the like) to generate and/or render one or more outputs (e.g., visual output, audio output, and haptic output) for one or more computing devices. In some embodiments, a game engine includes underlying frameworks and software for generating, simulating, or rendering one or more aspects of gameplay. As a non-limiting descriptive example, a game engine includes, among other things, a renderer, simulator, an audio engine, and a stream layer.

A renderer is a graphics framework that manages the rendering of graphics corresponding to lighting, shadows, textures, models, user interfaces, and other aspects of the like among a game engine. A simulator refers to a framework that manages simulation corresponding to physics and other corresponding mechanics - such as those used in part for driving or facilitating animations and/or interactions of gameplay objects, entities, characters, lighting, gasses, and other aspects of the like. A stream layer is a software layer that allows a renderer and simulator to execute independently of one another among a game engine by providing a common execution stream for renderings and simulations to be produced and/or synchronized (e.g., scheduled) at and/or during runtime. An audio engine or audio renderer provides audio playback among one or more audio channels. The output of an audio engine can also correspond to the common execution of a stream layer, for synchronization with rendering and simulation during runtime.

In some embodiments, the data of a video game includes state data, simulation data, rendering data, audio data, animation data, and other data of the like used and/or produced by or among a game engine during runtime execution.

State data is commonly known as data describing a state of a player character, virtual interactive environment, and/or other virtual objects, actors, or entities in whole or in part-at one or more instances or periods of time during a game session of a video game. For example, state data can include the current location and condition of one or more player characters among a virtual interactive environment at a given time, frame, or duration of time or number of frames.

Simulation data is commonly known as the underlying data corresponding to the simulation (e.g., physics and other corresponding mechanics) of a character or object in a game engine. For example, simulation data can include the joint and structural configuration of a character model and corresponding physical forces or characteristics applied to it at an instance or period of time during gameplay, such as a “frame”, to create animations, among other things.

Render Data is commonly known as the underlying data corresponding to rendering aspects (e.g., visual and auditory rendering) of a game session, which are rendered (e.g., for output to an output device) by a game engine. For example, render data can include data corresponding to the rendering of graphical, visual, auditory, and/or haptic output of a video game, among other things.

Digital game assets (or game assets in short) can include virtual objects, character models, actors, entities, geometric meshes, textures, terrain maps, animation files, audio files, digital media files, font libraries, visual effects, and other digital assets commonly used in video games of the like.

In some embodiments, a game session or gameplay is based in part on the data of a video game. One or more aspects of gameplay (e.g., rendering, simulation, state, interactions of player characters) uses, produces, generates, and/or modifies game data. Likewise, gameplay events, objectives, triggers, and other aspects, objects, or elements of the like also use, produce, generate, and/or modify data of a video game.

The data of a video game may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types of game data for processing and/or storage.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as but not limited to-graphics, audio, font, or communication support, establishing and maintaining service connections, performing authorizations, and providing anti-cheat and anti-fraud monitoring and detection, among other things.

Unless specifically stated otherwise, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method comprising:
identifying, by a video game, a plurality of slots in a video game and a plurality of characters that are rendered for participation in the video game at the plurality of slots;
placing a first character of the plurality of characters in a first slot of the plurality of slots;
based on a first assignment score of displacing the first character to a second slot of the plurality of slots, displacing the first character to the second slot and placing a second character of the plurality of characters in the first slot;
in response to adding a third character of the plurality of characters:
iteratively displacing the first character or the second character to a third slot of the plurality of slots and measuring corresponding assignment scores of the displacements, and
based on the corresponding assignment scores of the displacements of the first character or the second character, placing the third character in the first slot or the second slot; and
placing the plurality of characters in the video game in accordance with assignments and iterative displacement in the plurality of slots.

2. The computer-implemented method of claim 1, further comprising:
in response to determining that the first assignment score of displacing the first character to the second slot is less than the corresponding assignment scores of displacement, maintaining the first character at the first slot and the second character at the second slot.

3. The computer-implemented method of claim 1, further comprising:
determining a first angle between the first slot and a master slot of a master character in the plurality of characters; and
in response to a second angle between the second slot and the master slot being greater than the first angle, displacing the corresponding character at the second slot with the corresponding character at the first slot.

4. The computer-implemented method of claim 1, wherein the plurality of slots in the video game are defined in relation to an interaction scenario, and the interaction scenario defines interaction rules for the plurality of characters.

5. The computer-implemented method of claim 1, wherein the first character is placed in the first slot in accordance with matching parameters between the first character and the first slot.

6. The computer-implemented method of claim 5, wherein the parameters correspond with a distance between the first character and the first slot.

7. The computer-implemented method of claim 5, wherein the parameters correspond with an angle compared to a rotational threshold value between the first character and the first slot.

8. The computer-implemented method of claim 1, further comprising:
skipping placement of a fourth character of the plurality of characters that fails to qualify for at least one of the plurality of slots.

9. A video game comprising:
a memory storing instructions; and
a processor communicatively coupled to the memory and configured to execute the instructions to:
identify a plurality of slots in a video game and a plurality of characters that are rendered for participation in the video game at the plurality of slots;
place a first character of the plurality of characters in a first slot of the plurality of slots;
based on a first assignment score of displacing the first character to a second slot of the plurality of slots, displace the first character to the second slot and placing a second character of the plurality of characters in the first slot;
in response to adding a third character of the plurality of characters:
iteratively displace the first character or the second character to a third slot of the plurality of slots and measuring corresponding assignment scores of the displacements, and
based on the corresponding assignment scores of the displacements of the first character or the second character, place the third character in the first slot or the second slot; and
place the plurality of characters in the video game in accordance with assignments and iterative displacement in the plurality of slots.

10. The video game of claim 9, the processor further configured to:
in response to determining that the first assignment score of displacing the first character to the second slot is less than the corresponding assignment scores of displacement, maintain the first character at the first slot and the second character at the second slot.

11. The video game of claim 9, the processor further configured to:
determine a first angle between the first slot and a master slot of a master character in the plurality of characters; and
in response to a second angle between the second slot and the master slot being greater than the first angle, displace the corresponding character at the second slot with the corresponding character at the first slot.

12. The video game of claim 9, wherein the plurality of slots in the video game are defined in relation to an interaction scenario, and the interaction scenario defines interaction rules for the plurality of characters.

13. The video game of claim 9, wherein the first character is placed in the first slot in accordance with matching parameters between the first character and the first slot.

14. The video game of claim 13, wherein the parameters correspond with a distance between the first character and the first slot.

15. The video game of claim 13, wherein the parameters correspond with an angle compared to a rotational threshold value between the first character and the first slot.

16. The video game of claim 9, the processor further configured to:
skip placement of a fourth character of the plurality of characters that fails to qualify for at least one of the plurality of slots.

17. A non-transitory computer-readable storage medium storing a plurality of instructions executable by a processor, the plurality of instructions when executed by the processor cause the processor to:
identify a plurality of slots in a video game and a plurality of characters that are rendered for participation in the video game at the plurality of slots;
place a first character of the plurality of characters in a first slot of the plurality of slots;
based on a first assignment score of displacing the first character to a second slot of the plurality of slots, displace the first character to the second slot and placing a second character of the plurality of characters in the first slot;
in response to adding a third character of the plurality of characters:
iteratively displace the first character or the second character to a third slot of the plurality of slots and measuring corresponding assignment scores of the displacements, and
based on the corresponding assignment scores of the displacements of the first character or the second character, place the third character in the first slot or the second slot; and
place the plurality of characters in the video game in accordance with assignments and iterative displacement in the plurality of slots.

18. The non-transitory computer-readable storage medium of claim 17, wherein the processor is further caused to:
in response to determining that the first assignment score of displacing the first character to the second slot is less than the corresponding assignment scores of displacement, maintain the first character at the first slot and the second character at the second slot.

19. The non-transitory computer-readable storage medium of claim 17, wherein the processor is further caused to:
determine a first angle between the first slot and a master slot of a master character in the plurality of characters; and
in response to a second angle between the second slot and the master slot being greater than the first angle, displace the corresponding character at the second slot with the corresponding character at the first slot.

20. The non-transitory computer-readable storage medium of claim 17, wherein the plurality of slots in the video game are defined in relation to an interaction scenario, and the interaction scenario defines interaction rules for the plurality of characters.
